(19) United States
(12) Patent Application Publication
(10) Pub. No.: US 2023/0081001 A1
(43) Pub. Date: Mar. 16, 2023

(54) HOLLOW SPHERICAL CERIUM DIOXIDE NANOMATERIAL AND PREPARATION METHOD AND APPLICATION THEREOF

(71) Applicant: QILU UNIVERSITY OF TECHNOLOGY, Jinan, Shandong (CN)

(72) Inventors: Guowei ZHOU, Jinan (CN); Qinghua GONG, Jinan (CN); Tingting GAO, Jinan (CN); Bin SUN, Jinan (CN); Yongqiang REN, Jinan (CN); Qian WANG, Jinan (CN); Xuefeng SUN, Jinan (CN)

(73) Assignee: QILU UNIVERSITY OF TECHNOLOGY, Jinan, Shandong (CN)

(21) Appl. No.: 17/802,435

(22) PCT Filed: Dec. 2, 2021
(86) PCT No.: PCT/CN2021/135138

§ 371 Date: Aug. 25, 2022

(30) Foreign Application Priority Data
Jan. 15, 2021 (CN) 202110054874.5

(51) Int. Cl. H01M 4/48; H01M 4/13; H01M 10/0525; H01M 50/417; H01M 10/0568; H01M 10/0569; C01F 17/235

(52) U.S. Cl. CPC H01M 4/483; C01F 17/235; H01M 4/13; H01M 10/0525; H01M 10/0568; H01M 10/0569; H01M 50/417; H01M 2004/021

(57) ABSTRACT

A hollow spherical cerium dioxide nanomaterial, preparation method and application thereof; wherein the preparation method uses glucose as a carbon source, urea as a precipitant, cerium trichloride as a cerium source, and water as a solvent to prepare a cerium dioxide/carbon composite material by a hydrothermal method, and then, a hollow spherical cerium dioxide nanomaterial with a multi-shell layer structure is obtained by calcination in a muffle furnace. By adjusting the amount of urea and the calcination temperature, a number of shell layers of the material can be adjusted. Moreover, in the nanomaterial, the number of shell layers can be adjusted, large spacing exists between shell layers, specific surface area can be increased, wherein contact area of the material with an electrolyte increases, but also structural collapse caused by a volume expansion of an electrode material during charging and discharging can be alleviated, and the electrochemical performance is effectively improved.

### TECHNICAL FIELD

The present disclosure belongs to the technical field of lithium-ion batteries and relates to a hollow spherical cerium dioxide nanomaterial and a preparation method and application thereof.

### BACKGROUND

Information of the Related Art part is merely disclosed to increase the understanding of the overall background of the present disclosure, but is not necessarily regarded as acknowledging or suggesting, in any form, that the information constitutes the prior art known to a person of ordinary skill in the art.

Cerium dioxide, as a rare earth metal oxide, has a unique chemical property of redox due to the presence of two oxidation states of cerium (Ce³⁺ and Ce⁴⁺), thereby having a very wide range of applications such as catalysis, secondary batteries (e.g., lithium-ion batteries, lithium-sulfur batteries or the like), and supercapacitors.

The cerium dioxide, whether as a catalytic material or an electrode material, has the performance which is greatly dependent on its specific surface area. Increasing the specific surface area of the cerium dioxide can greatly improve the performance thereof in catalysis and as an energy storage electrode material. Therefore, nanosizing the cerium dioxide or making the cerium dioxide into a hollow structure is a very effective way to increase the specific surface area. However, when the cerium dioxide is used as an electrode material, there is a volume expansion of cerium ions due to the change of a valence state with the electrode charged and discharged, making the electrode easy to collapse, and leading to a sharp decrease in performance.

In the application process, due to poor electrical conductivity, the performance of the cerium dioxide does not achieve better effects. For example, when the cerium dioxide serves as a lithium-ion battery electrode material, due to lower electrical conductivity, specific capacity, rate performance and cycle stability of the cerium dioxide are lower. Therefore, in order to improve the performance of the cerium dioxide and application thereof, there is still a need to design a new structure to solve the problems that exist in the current application.

China Patent Document Publication No. CN 108022758B discloses a patent of a carbon coated cerium dioxide hollow sphere and a preparation method therefor. The synthesis method of the patent includes: firstly taking silicon dioxide as a template to obtain a cerium dioxide coated silicon dioxide microsphere by a hydrothermal reaction; using a carbon source to coat the cerium dioxide coated silicon dioxide microsphere to obtain a primary product; under a protective gas atmosphere, sintering the primary product to obtain a carbon coated cerium dioxide microsphere; and etching the carbon coated cerium dioxide microsphere with an etching agent to obtain a carbon coated cerium dioxide hollow sphere. The preparation process is complicated, and also needs to etch the template, which is not conducive to large-scale production.

The inventor research found that hollow spherical cerium dioxide prepared by the above patent not only needs the template, and has a complicated preparation method, but also cannot control shell layers of the hollow sphere. It is difficult to control the specific surface area and lithium-ion storage sites of the hollow spherical cerium dioxide.

### SUMMARY

In order to solve shortcomings of the prior art, the present disclosure aims to provide a hollow spherical cerium dioxide nanomaterial and a preparation method and application thereof. The preparation method in the present disclosure does not need a template agent, and a number of shell layers is adjustable. The present disclosure is simple in the preparation method, safe in the process, low in energy consumption and highly operable. The provided hollow spherical cerium dioxide has a multi-layer shell structure.

In order to achieve the above objective, the present disclosure adopts the technical solution:

On the one hand, a hollow spherical cerium dioxide nanomaterial has a particle size of 400-800 nm, a number of shell layers of 1-3, a thickness of the shell layers of 30-50 nm, and spacing between the shell layers of 100-200 nm.

On the other hand, a method for preparing a hollow spherical cerium dioxide nanomaterial includes: adding cerium trichloride to an aqueous urea solution; adding a glucose solution in the process of mixing; stirring well, and then carrying out a hydrothermal reaction; and calcining a precipitate obtained by the hydrothermal reaction to obtain a hollow spherical multi-shell layer cerium dioxide nanomaterial.

The present disclosure found through experiments that: 1. The order of material addition affects the formation of a cerium dioxide hollow sphere. 2. An anion in a cerium source affects adjustment to a number of shell layers of the hollow sphere. 3. The amount of urea addition can adjust the number of shell layers. When the above method uses cerium trichloride as the cerium source, the number of shell layers of cerium dioxide can be regulated by changing the amount of urea. However, when cerium nitrate is used as the cerium source, only nano-spherical cerium dioxide can be prepared with the above method, and the number of shell layers of cerium dioxide cannot be adjusted by adjusting the amount of urea addition.

In a third aspect, a method for adjusting a number of shell layers of a hollow spherical structure of a cerium dioxide nanomaterial includes the preparation method described above, and the number of shell layers of the hollow spherical structure is adjusted by adjusting the amount of urea.

In a fourth aspect, application of the hollow spherical structured cerium dioxide nanomaterial described above in electronic materials, magnetic materials, catalytic materials, sensing materials, optoelectronic materials or energy storage materials is provided.

In a fifth aspect, a lithium-ion battery negative electrode includes a negative electrode material, a conductive agent, a binder and a current collector, and the negative electrode material is the hollow spherical multi-shell layer structured cerium dioxide nanomaterial described above.

In a sixth aspect, a lithium-ion battery includes the lithium-ion battery negative electrode described above, a positive electrode, a separator and an electrolyte.

The present disclosure has the following beneficial effects.
1. The present disclosure provides a method for preparing a hollow spherical multi-shell layer structured cerium dioxide nanomaterial, and a number of shell layers can be regulated by changing the amount of urea addition.
2. The present disclosure uses a hydrothermal method to prepare the hollow spherical multi-shell layer structured cerium dioxide nanomaterial, and this method is simple in preparation process, easy to operate, safe and environmentally friendly.
3. The hollow spherical multi-shell layer structured cerium dioxide nanomaterial prepared by the present disclosure is calcined at a low temperature for a short time, which is less polluting to the environment.
4. The present disclosure uses environment-friendly chemical reactant raw materials, the process operation is easy to implement, the preparation process is reproducible, clean and pollution-free and low cost, and provides a new idea for preparing hollow spherical multi-shell layer structured cerium dioxide nanomaterial.
5. The hollow spherical multi-shell layer structured cerium dioxide nanomaterial prepared by the present disclosure has an obvious hollow spherical multi-shell layer structure. Compared with other morphology, the hollow spherical multi-shell layer structured nanomaterial has a larger specific surface area, a lower volume expansion, and more excellent cycling, multiplicity and stability.
6. The hollow spherical multi-shell layer structured cerium dioxide nanomaterial prepared by the present disclosure, used as a lithium-ion battery negative electrode material, can increase the contact area between the electrode material and the electrolyte, and provide more active sites, making it a good prospect for application in electrochemistry.
7. The hollow spherical multi-shell layer structured cerium dioxide nanomaterial prepared by the present disclosure has good dispersion and no obvious aggregation, and reduces interfacial resistance in the charge transfer process, preparing for further study of electrochemical properties.
8. The hollow spherical multi-shell layer structured cerium dioxide nanomaterial prepared by the present disclosure has large spacing between shell layers of about 100-200 nm. The preparation process is simple to operate and provides a reference for preparing a hollow spherical multi-shell layer structured material.

### BRIEF DESCRIPTION OF THE DRAWINGS

The accompanying drawings constituting a part of the present disclosure are used for providing a further understanding of the present disclosure. The schematic embodiments and description of the present disclosure are intended to explain the present disclosure, and do not constitute improper restriction to the present disclosure.

FIG. 1 is a transmission electron microscopy (TEM) image of a hollow spherical tri-shell layer structured cerium dioxide nanomaterial prepared in Example 1 of the present disclosure.

FIG. 2 is a TEM image of a hollow spherical single-shell layer structured cerium dioxide nanomaterial prepared in Example 2 of the present disclosure.

FIG. 3 is a TEM image of a hollow spherical double-shell layer structured cerium dioxide nanomaterial prepared in Example 3 of the present disclosure.

FIG. 4 is an X-ray diffraction (XRD) image of a hollow spherical tri-shell layer structured cerium dioxide nanomaterial prepared in Example 1 of the present disclosure.

FIG. 5 is a charge/discharge curve graph of a lithium-ion battery of a hollow spherical multi-shell layer structured cerium dioxide nanomaterial prepared in Example 1 of the present disclosure.

### DETAILED DESCRIPTION

It should be noted that, the following detailed descriptions are all exemplary, and are intended to provide further descriptions of the present disclosure. Unless otherwise specified, all technical and scientific terms used herein have the same meaning as commonly understood by a person of ordinary skill in the art to which the present disclosure belongs.

It should be noted that the terms used herein are merely used for describing specific implementations, and are not intended to limit exemplary implementations of the present disclosure. As used herein, the singular form is also intended to include the plural form unless the context clearly dictates otherwise. In addition, it should further be understood that, terms “comprise” and/or “include” used in this specification indicate that there are features, steps, operations, devices, components, and/or combinations thereof.

In view of the problems that the existing methods for preparing hollow spherical cerium dioxide require template agents and it is difficult to adjust a number of shell layers, the present disclosure provides a hollow spherical multi-shell layer cerium dioxide nanomaterial and a preparation method and application thereof.

A typical embodiment of the present disclosure provides a hollow spherical cerium dioxide nanomaterial having a particle size of 400-800 nm, a number of shell layers of 1-3, a thickness of the shell layers of 30-50 nm, and spacing between the shell layers of 100-200 nm.

Another embodiment of the present disclosure provides a method for preparing a hollow spherical multi-shell layer cerium dioxide nanomaterial, including: adding cerium trichloride to an aqueous urea solution; adding a glucose solution in the process of mixing; stirring well, and then carrying out a hydrothermal reaction; and calcining a precipitate obtained by the hydrothermal reaction to obtain a hollow spherical multi-shell layer cerium dioxide nanomaterial.

The present disclosure facilitates the formation of the cerium dioxide hollow sphere by the sequence of material addition in combination with the hydrothermal method and calcination. A number of shell layers of the hollow spherical multi-shell layer cerium dioxide nanomaterial is regulated by selecting cerium trichloride as the cerium source and adjusting the urea content.

The molecular weights of the glucose, urea, and CeCl₃ · 7H₂O are 180.16 g mol⁻¹, 60.06 g mol⁻¹, and 246.67 g mol⁻¹, respectively.

In some examples of the embodiment, water in the aqueous urea solution and water in the glucose solution are ultrapure water. The ultrapure water described in the present disclosure is water having a resistivity of not less than 10 MQ*cm. It is able to prevent impurities in the water from affecting the structure of the cerium dioxide.

In some examples of the embodiment, the concentration of the aqueous urea solution is 0.00-32.00 g/L.

In some examples of the embodiment, the concentration of the glucose solution is 0.00-13.00 g/L.

In some examples of the embodiment, a molar ratio of addition of cerium trichloride to urea to glucose is 0.275: 0-6.260: 0-1.443.

In some examples of the embodiment, the hydrothermal reaction is carried out at 150-200° C. for 15-25 h.

In some examples of the embodiment, a volume ratio of water to a reaction kettle in the hydrothermal reaction is 30-40:100.

In some examples of the embodiment, the calcination is carried out at 300-500° C. for 400-500 min.

In some examples of the embodiment, the hydrothermal reaction is carried out by stirring for 25-30 min after adding the glucose solution.

In some examples of the embodiment, the precipitate is separated by centrifugation after the hydrothermal reaction, cleaned and dried, and then calcined. Distilled water and ethanol are used for cleaning. Blast drying is carried out at 75-85° C. for 20-30 h.

Hollow spherical multi-shell layer cerium dioxide prepared by any one of the above methods is uniformly dispersed, and has a uniform particle size and a distinct multi-shell layer structure. The hollow spherical multi-shell layer cerium dioxide has a particle size of 400-800 nm, a number of shell layers of 1-3, a thickness of the shell layers of 30-50 nm, and spacing between the shell layers of 100-200 nm.

It is to be noted that, in the method for preparing hollow spherical multi-shell layer cerium dioxide in the present disclosure, if any one of the conditions of the method is changed, the prepared product may change in morphology and size, instead of morphology in the present disclosure, and in turn will affect the application performance of a composite material.

The cerium dioxide nanomaterial prepared by the present disclosure has a distinct hollow spherical multi-shell layer structure. Compared with other morphology, the hollow spherical multi-shell layer structured nanomaterial has a larger specific surface area, a lower volume expansion, and more excellent cycling, multiplicity and stability.

A third embodiment of the present disclosure provides a method for adjusting a number of shell layers of a hollow spherical structure of a cerium dioxide nanomaterial, including the preparation method described above, and the number of shell layers of the hollow spherical structure is adjusted by adjusting the amount of urea.

A fourth embodiment of the present disclosure provides application of the hollow spherical multi-shell layer structured cerium dioxide nanomaterial described above in electronic materials, magnetic materials, catalytic materials, sensing materials, optoelectronic materials or energy storage materials.

Specifically, the application is application of the hollow spherical multi-shell layer structured cerium dioxide nanomaterial described above in a lithium-ion battery negative electrode material.

A fifth embodiment of the present disclosure provides a lithium-ion battery negative electrode, including a negative electrode material, a conductive agent, a binder and a current collector. The negative electrode material is the hollow spherical multi-shell layer structured cerium dioxide nanomaterial described above.

A sixth embodiment of the present disclosure provides a lithium-ion battery, including the lithium-ion battery negative electrode described above, a positive electrode, a separator and an electrolyte.

In some examples of the embodiment, the positive electrode is a lithium sheet.

In some examples of the embodiment, the separator is a polypropylene membrane.

In some examples of the embodiment, the electrolyte is a mixture of LiPF₆, vinyl carbonate, dimethyl carbonate, and methyl ethyl carbonate.

The hollow spherical multi-shell layer structured cerium dioxide nanomaterial prepared by the present disclosure is used as a lithium-ion battery negative electrode material, can increase the contact area between the electrode material and the electrolyte, and provide more active sites.

The prepared hollow spherical multi-shell layer structured cerium dioxide nanomaterial is used as a lithium-ion battery negative electrode material having a discharge specific capacity of 995.9 mAh g⁻¹ at a current density of 100 mA g⁻¹.

In order to enable those skilled in the art to understand the technical solutions of the present disclosure more clearly, the technical solutions of the present disclosure will be described in detail below with reference to specific embodiments.

### Example 1

0.130 g of glucose was dissolved in 20 mL of ultrapure water.

0.376 g of urea was dissolved in 12 mL of ultrapure water.

0.068 g of CeCl₃ · 7H₂O was added to the solution obtained in step (2).

The solution obtained in step (3) was added to the solution obtained in step (1) with constant stirring, and stirring was continued for 30 min.

The mixed solution obtained in step (4) was transferred to a 100 mL PTFE-lined autoclave.

The autoclave in step (5) was screwed into an oven and kept at 160° C. for 20 h and then cooled naturally to room temperature.

A precipitate obtained in step (6) was separated by centrifugation, washed with distilled water and ethanol for 3 times respectively, dried in a blast drying oven at 80° C. for 24 h, and ground to collect a product.

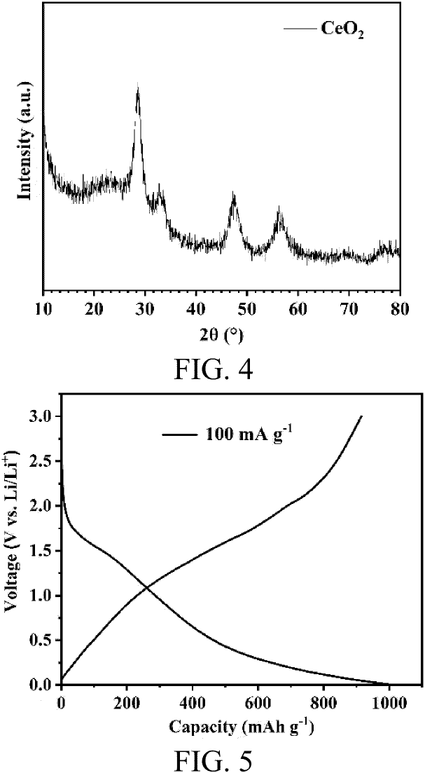

The solid powder obtained in step (7) was kept in a muffle furnace at 400° C. for 450 min, and calcined to obtain a hollow spherical tri-shell layer structured cerium dioxide nanomaterial. An XRD image thereof is shown in FIG. 4.

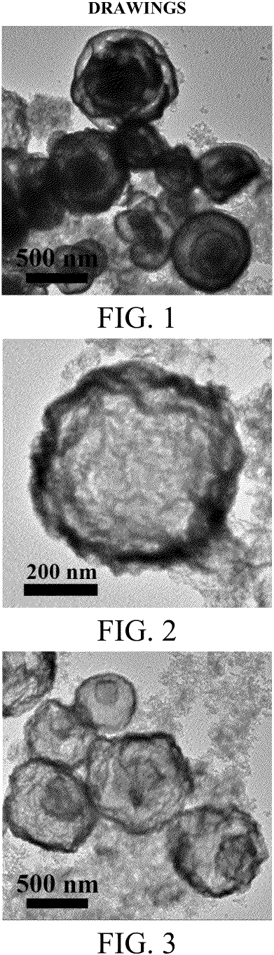

Observed by transmission electron microscopy, as shown in FIG. 1, the hollow spherical multi-shell layer structured cerium dioxide nanomaterial prepared by the method has a diameter of 400-800 nm, a number of shell layers of 3, a thickness of the shell layers of 30-50 nm, and spacing between the shell layers of 100-200 nm.

### Example 2

0.130 g of glucose was dissolved in 32 mL of ultrapure water.

0.068 g of CeC1₃ 7H₂O was added to the solution obtained in step (1), and stirring was continued for 30 min.

The mixed solution obtained in step (2) was transferred to a 100 mL PTFE-lined autoclave.

The autoclave in step (3) was screwed into an oven and kept at 160° C. for 20 h and then cooled naturally to room temperature.

A precipitate obtained in step (4) was separated by centrifugation, washed with distilled water and ethanol for 3 times respectively, dried in a blast drying oven at 80° C. for 24 h, and ground to collect a product.

The solid powder obtained in step (5) was kept in a muffle furnace at 400° C. for 450 min, and calcined to obtain a hollow spherical single-shell layer structured cerium dioxide nanomaterial.

Observed by transmission electron microscopy, as shown in FIG. 2, the cerium dioxide nanomaterial prepared by the method has a diameter of 500 nm, a number of shell layers of 1, a thickness of the shell layers of 50 nm, and a cavity diameter of about 400 nm.

### Example 3

0.260 g of glucose was dissolved in 20 mL of ultrapure water.

0.188 g of urea was dissolved in 12 mL of ultrapure water.

0.067 g of CeCl₃ · 7H₂O was added to the solution obtained in step (2).

The solution obtained in step (3) was added to the solution obtained in step (1) with constant stirring, and stirring was continued for 30 min.

The mixed solution obtained in step (4) was transferred to a 100 mL PTFE-lined autoclave.

The autoclave in step (5) was screwed into an oven and kept at 160° C. for 20 h and then cooled naturally to room temperature.

A precipitate obtained in step (6) was separated by centrifugation, washed with distilled water and ethanol for 3 times respectively, dried in a blast drying oven at 80° C. for 24 h, and ground to collect a product.

The solid powder obtained in step (7) was kept in a muffle furnace at 400° C. for 450 min, and calcined to obtain a hollow spherical double-shell layer structured cerium dioxide nanomaterial.

Observed by transmission electron microscopy, as shown in FIG. 3, the hollow spherical multi-shell layer structured cerium dioxide nanomaterial prepared by the method has a diameter of 400-800 nm, a number of shell layers of 2, a thickness of the shell layers of 30-50 nm, and spacing between the shell layers of 200-300 nm.

### Example 4

0.376 g of urea was dissolved in 32 mL of ultrapure water.

0.068 g of CeCl₃ 7H₂O was added to the solution obtained in step (1), and stirring was continued for 30 min.

The mixed solution obtained in step (2) was transferred to a 100 mL PTFE-lined autoclave.

The autoclave in step (3) was screwed into an oven and kept at 160° C. for 20 h and then cooled naturally to room temperature.

A precipitate obtained in step (4) was separated by centrifugation, washed with distilled water and ethanol for 3 times respectively, dried in a blast drying oven at 80° C. for 24 h, and ground to collect a product.

The solid powder obtained in step (5) was kept in a muffle furnace at 400° C. for 450 min , and calcined to obtain a cerium dioxide nanomaterial.

### Example 5

0.260 g of glucose was dissolved in 20 mL of ultrapure water.

0.376 g of urea was dissolved in 12 mL of ultrapure water.

0.068 g of CeCl_{3·} H₂O was added to the solution obtained in step (2).

The solution obtained in step (3) was added to the solution obtained in step (1) with constant stirring, and stirring was continued for 30 min.

The mixed solution obtained in step (4) was transferred to a 100 mL PTFE-lined autoclave.

The autoclave in step (5) was screwed into an oven and kept at 160° C. for 20 h and then cooled naturally to room temperature.

A precipitate obtained in step (6) was separated by centrifugation, washed with distilled water and ethanol for 3 times respectively, dried in a blast drying oven at 80° C. for 24 h, and ground to collect a product.

The solid powder obtained in step (7) was kept in a muffle furnace at 400° C. for 450 min, and calcined to obtain a cerium dioxide nanomaterial.

### Example 6

0.130 g of glucose was dissolved in 20 mL of ultrapure water.

0.376 g of urea was dissolved in 12 mL of ultrapure water.

0.068 g of CeC1_{3·}7H₂O was added to the solution obtained in step (2).

The solution obtained in step (3) was added to the solution obtained in step (1) with constant stirring, and stirring was continued for 30 min.

The mixed solution obtained in step (4) was transferred to a 100 mL PTFE-lined autoclave.

The autoclave in step (5) was screwed into an oven and kept at 160° C. for 20 h and then cooled naturally to room temperature.

A precipitate obtained in step (6) was separated by centrifugation, washed with distilled water and ethanol for 3 times respectively, dried in a blast drying oven at 80° C. for 24 h, and ground to collect a product.

The solid powder obtained in step (7) was kept in a muffle furnace at 300° C. for 450 min, and calcined to obtain a cerium dioxide nanomaterial.

### Example 7

0.130 g of glucose was dissolved in 20 mL of ultrapure water.

0.376 g of urea was dissolved in 12 mL of ultrapure water.

0.068 g of CeCl₃ · 7H₂O was added to the solution obtained in step (2).

The solution obtained in step (3) was added to the solution obtained in step (1) with constant stirring, and stirring was continued for 30 min.

The mixed solution obtained in step (4) was transferred to a 100 mL PTFE-lined autoclave.

The autoclave in step (5) was screwed into an oven and kept at 160° C. for 20 h and then cooled naturally to room temperature.

A precipitate obtained in step (6) was separated by centrifugation, washed with distilled water and ethanol for 3 times respectively, dried in a blast drying oven at 80° C. for 24 h, and ground to collect a product.

The solid powder obtained in step (7) was kept in a muffle furnace at 500° C. for 450 min, and calcined to obtain a cerium dioxide nanomaterial.

### Example 8

An electrode material of a lithium-ion battery used the hollow spherical multi-shell layer structured cerium dioxide nanomaterial in Example 1 as a lithium-ion battery negative electrode material. A lithium sheet was used as a positive electrode. A polypropylene membrane was used as a separator. A mixture of LiPF₆, vinyl carbonate, dimethyl carbonate, and methyl ethyl carbonate was used as an electrolyte. The cerium dioxide nanomaterial, conductive carbon black and PTFE were ground and dispersed in N-methyl pyrrolidone in a mass ratio of 8:1:1 until a uniform slurry was obtained. The slurry was evenly applied to copper foil with a coating machine, and then dried and cut into a circular electrode sheet with a diameter of 12 mm with a slicer, with a loading of about 1.0 mg. Assembly was performed to obtain a CR2032 button cell in a glove box filled with argon gas. Then the charge and discharge performance was tested with LAND-CT2001A. As shown in FIG. 5, the discharge specific capacity was 995.9 mAh g⁻¹ at a current density of 100 mA g⁻¹. It is tested and determined that the lithium-ion battery is very suitable for application in electrochemistry.

The product in the examples described above was tested and determined in the TEM image that a hollow spherical multi-shell layer structured cerium dioxide nanomaterial was successfully prepared. By exploring a series of influencing factors, the experimental conditions of the present disclosure are optimal, and the product has regular, uniform and well-dispersed morphology.

The above descriptions are merely preferred embodiments of the present disclosure and are not intended to limit the present disclosure. A person skilled in the art may make various alterations and variations to the present disclosure. Any modification, equivalent replacement, or improvement made within the spirit and principle of the present disclosure shall fall within the protection scope of the present disclosure.

What is claimed is:

1. A method for preparing a hollow spherical cerium dioxide nanomaterial, comprising: adding cerium trichloride to an aqueous urea solution; adding a glucose solution in the process of mixing; stirring well, and then carrying out a hydrothermal reaction; and calcining a precipitate obtained by the hydrothermal reaction to obtain the hollow spherical multi-shell layer cerium dioxide nanomaterial, wherein the hydrothermal reaction is carried out at 150-200° C. for 15-25 h, the calcination is carried out at 300-500° C. for 400-500 min, and the hollow spherical multi-shell layer cerium dioxide nanomaterial has a particle size of 400-800 nm, a number of shell layers of 2-3 layers, a thickness of the shell layers of 30-50 nm, and spacing between the shell layers of 100-200 nm.

2. The method for preparing a hollow spherical cerium dioxide nanomaterial according to claim 1, wherein water in the aqueous urea solution and water in the glucose solution are ultrapure water.

3. The method for preparing a hollow spherical cerium dioxide nanomaterial according to claim 2, wherein a concentration of the aqueous urea solution is greater than 0 g/L and less than or equal to 32.00 g/L.

4. The method for preparing a hollow spherical cerium dioxide nanomaterial according to claim 2, wherein a concentration of the glucose solution is greater than 0 g/L and less than or equal to 13.00 g/L.

5. The method for preparing a hollow spherical cerium dioxide nanomaterial according to claim 1, wherein a molar ratio of addition of the cerium trichloride to urea to glucose is 0.275: 0-6.260: 0-1.443, wherein a molar amount of addition of the urea and the glucose is greater than 0.

6. The method for preparing a hollow spherical cerium dioxide nanomaterial according to claim 1, wherein a volume ratio of water to a reaction kettle in the hydrothermal reaction is 30-40:100.

7. A method for adjusting a number of shell layers of a hollow spherical structure of a cerium dioxide nanomaterial, comprising the preparation method according to claim 1, wherein the number of shell layers of the hollow spherical structure is adjusted by adjusting the amount of the urea.

8. Application of the hollow spherical cerium dioxide nanomaterial obtained by the preparation method according to claim 1 in electronic materials, magnetic materials, catalytic materials, sensing materials, optoelectronic materials or energy storage materials.

9. The application according to claim 8, wherein the application is application of the hollow spherical structured cerium dioxide nanomaterial in a lithium-ion battery negative electrode material.

10. A lithium-ion battery negative electrode, comprising a negative electrode material, a conductive agent, a binder and a current collector, wherein the negative electrode material is the hollow spherical structured cerium dioxide nanomaterial obtained by the preparation method according to claim 1.

11. A lithium-ion battery, comprising the lithium-ion battery negative electrode according to claim 10, a positive electrode, a separator and an electrolyte.

12. The lithium-ion battery according to claim 11, wherein the separator is a polypropylene membrane.

13. The lithium-ion battery according to claim 11, wherein the electrolyte is a mixture of LiPF₆, vinyl carbonate, dimethyl carbonate, and methyl ethyl carbonate.
